(19) United States
(12) Patent Application Publication
(10) Pub. No.: US 2022/0224881 A1
(43) Pub. Date: Jul. 14, 2022

(54) METHOD, APPARATUS, AND DEVICE FOR CAMERA CALIBRATION, AND STORAGE MEDIUM

(71) Applicant: SenseBrain Technology Limited LLC, Princeton, NJ (US)

(72) Inventors: Felipe GUTIERREZ-BARRAGAN, Princeton, NJ (US); Huaijin CHEN, Princeton, NJ (US); Jinwei GU, Princeton, NJ (US)

(21) Appl. No.: 17/706,946

(22) Filed: Mar. 29, 2022

(51) Int. Cl. H04N 17/00; G06T 7/521; G06T 7/70; G06V 10/82; G06V 10/774

(52) U.S. Cl. CPC H04N 17/002; G06T 7/521; G06T 7/70; G06V 10/82; G01S 17/894; G06T 2207/20084; G06T 2207/20081; G06T 2207/30244; G06T 2207/10028; G06V 10/7747

(57) ABSTRACT

A method, apparatus and device for camera calibration, and a storage medium. A camera to be calibrated for performing depth estimation on a scene is determined. A first correlation function for characterizing a correlation between a sensor modulation signal of the camera to be calibrated and a first modulated light emission signal is determined. A second correlation function for characterizing an actual correlation function produced by the camera to be calibrated is determined. A calibrated impulse response based on the first correlation function and the second correlation function is determined. The camera to be calibrated is calibrated based on the calibrated impulse response, to obtain the calibrated camera.

### TECHNICAL FIELD

The present disclosure relates to computer vision, and particularly relates to a method, apparatus, and device for camera calibration, and a storage medium.

### BACKGROUND

In the depth map processing methods of the related art, for cyclic error generated when a ToF camera measures a depth map, the cyclic error is usually calibrated based on the frequency of the ToF. Whenever a different frequency is configured for the ToF camera, it is necessary to perform periodic calibration, resulting in a complex process of error calibration.

### SUMMARY

According to a first aspect, a method for camera calibration is provided. The method includes the following actions. A camera to be calibrated for performing depth estimation on a scene is determined. A first correlation function for characterizing a correlation between a sensor modulation signal of the camera to be calibrated and a first modulated light emission signal is determined. A second correlation function for characterizing an actual correlation function produced by the camera to be calibrated is determined. A calibrated impulse response is determined based on the first correlation function and the second correlation function. The camera to be calibrated is calibrated based on the calibrated impulse response, to obtain the calibrated camera.

According to a second aspect, an apparatus for camera calibration is provided. The apparatus includes a first determination module, a first correlation module, a second correlation module, a second determination module, and a first calibration module. The first determination module is configured to determine a camera to be calibrated for performing depth estimation on a scene. The first correlation module is configured to determine a first correlation function for characterizing a correlation between a sensor modulation signal of the camera to be calibrated and a first modulated light emission signal. The second correlation module is configured to determine a second correlation function for characterizing an actual correlation function produced by the camera to be calibrated. The second determination module is configured to determine a calibrated impulse response based on the first correlation function and the second correlation function. The first calibration module is configured to calibrate the camera to be calibrated based on the calibrated impulse response, to obtain the calibrated camera.

According to a third aspect, a computer readable storage medium is provided. The computer readable storage medium has computer executable instructions stored thereon, and the computer executable instructions, when executed by a processor, cause the processor to implement the method according to the first aspect.

According to a fourth aspect, a device for camera calibration is provided. The device for camera calibration includes a memory and a processor, the memory stores computer executable instructions, and the computer executable instructions, when executed by the processor, cause the processor to implement the method according to the first aspect.

The embodiments of the present application provide a method, apparatus, and device for camera calibration, and a storage medium. First, the first correlation function between the sensor modulation signal of the camera to be calibrated and the first modulated light emission signal is determined, and the second correlation function actually produced by the camera to be calibrated is determined; then the calibrated impulse response is determined based on the first correlation function and the second correlation function. In this way, by calibrating the assumed impulse response of the sensor, the process of calibrating the coder in the camera is omitted. Finally, the camera to be calibrated is calibrated based on the calibrated impulse response to obtain the calibrated camera. Therefore, by calibrating the impulse response of the sensor, the error in the depth estimation of the camera can be eliminated, and no further calibration is needed in the subsequent use of the camera, which simplifies the entire implementation process.

### BRIEF DESCRIPTION OF THE DRAWINGS

FIG. 1A is a flow chart of a method for camera calibration according to some embodiments of the disclosure.

FIG. 1B is a block diagram of a device for camera calibration according to some embodiments of the disclosure.

FIG. 1C is a schematic diagram of a process of calibrating an impulse response according to an embodiment of the disclosure.

FIG. 2A is a flow chart of a method for camera calibration according to some embodiments of the disclosure.

FIG. 2B is a schematic view of the operating principle of an iToF sensor according to some embodiments of the disclosure.

FIG. 3A is a schematic diagram of a simulation result of a method for camera calibration according to an embodiment of the disclosure.

FIG. 3B is a schematic diagram of a simulation result of cyclic calibration according to an embodiment of the disclosure.

FIG. 3C is a schematic diagram of a simulation result of the measured correlation functions and the lookup table according to an embodiment of the disclosure.

FIG. 3D is a diagram of a simulation result of calibration of an impulse response according to some embodiments of the disclosure.

FIG. 4 is a diagram of a simulation result of the method for camera calibration according to some embodiments of the disclosure.

FIG. 5 is a schematic diagram of a framework of an iToF simulation pipeline according to some embodiments of the disclosure.

FIG. 6 is a schematic diagram of an application scenario of the method for camera calibration according to some embodiments of the disclosure.

FIG. 7 is a schematic diagram of an application scenario of the method for camera calibration according to some embodiments of the disclosure.

FIG. 8 is a block diagram of an apparatus for camera calibration according to some embodiments of the disclosure.

FIG. 9 is a block diagram of a device for camera calibration according to some embodiments of the disclosure.

### DETAILED DESCRIPTION

In order to make the objectives, technical solutions, and advantages of the embodiments of the disclosure clearer, the specific technical solutions of the invention will be described in further detail below in conjunction with the drawings in the embodiments of the disclosure. The following examples are used to illustrate the disclosure, but are not used to limit the scope of the disclosure.

In the following description, “some embodiments” are referred to, which describe a subset of all possible embodiments, but it is to be understood that “some embodiments” may be the same subset or different subsets of all possible embodiments, and can be combined with each other without conflict.

In the following description, the term “first/second/third” is only used to distinguish similar objects, and does not represent a specific order of the objects. It is to be understood that, the specific order or sequence of “first/second/third”, where permitted, can be interchanged, so that the embodiments of the disclosure described herein can be implemented in a sequence other than those illustrated or described herein.

Unless otherwise defined, all technical and scientific terms used herein have the same meaning as commonly understood by those skilled in the technical field of the disclosure. The terminology used herein is only for the purpose of describing the embodiments of the disclosure, and is not intended to limit the disclosure.

Before describing the embodiments of the disclosure in further detail, the terms and terms involved in the embodiments of the disclosure will be described. The terms and terms involved in the embodiments of the disclosure are applicable to the following interpretations.

1) Time-of-Flight (ToF): a TOF measurement device includes a light source, an optics component, a sensor, a control circuit, a processing circuit, and etc. A target object is lighted, the transmission time of the light between the lens and the object is measured, the distance between the object and the acquisition device is calculated, and a distance of each object in the screen to the acquisition device is determined, to obtain a depth map; and finally, a stereo image is drawn based on the depth map, to achieve three dimensional (3D) stereo depth sensing.

2) iToF: in the indirect time-of-flight technology, modulated light is used to illuminate the scene, and the phase delay of the returning light after being reflected by object in the scene is measured. When the phase delay is obtained, the quadrature sampling technique is used to measure and convert the phase delay into distance. In this way, it requires a small calculation amount and a small space, and has a relatively low cost and a high frame rate.

3) Calibration: in related technologies, variance of external devices may cause inaccurate measurement. Generally, there is deviation within a certain range, and the result needs to be corrected by program algorithms or parameters. This process is called calibration. In the embodiments of the disclosure, calibration refers to determining the difference between the actual output waveform of a sensor and the ideal waveform of the sensor.

The following describes an exemplary application of the device for depth estimation according to the embodiment of the disclosure. The device according to the embodiment of the disclosure may be implemented as various types of user terminals, such as a notebook computer, a tablet computer, a desktop computer, a camera, a mobile device (for example, a personal digital assistant, a dedicated messaging device, and a portable game device), or may be implemented as a server. In the following, an exemplary application in which the device is implemented as a terminal or a server will be described.

The method can be applied to a device for camera calibration, and the functions implemented by the method can be implemented by a processor in the device for camera calibration through calling program codes. Of course, the program codes can be stored in a computer storage medium. It can be seen that the device for camera calibration at least includes a processing device and a storage medium.

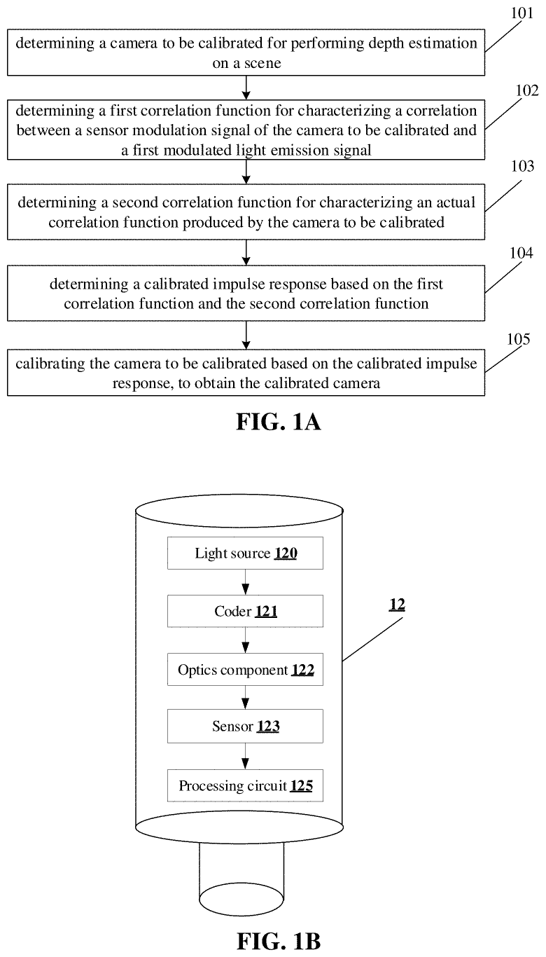

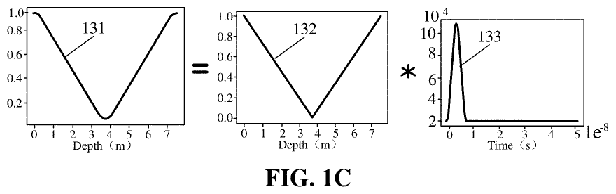

FIG. 1A is a flow chart of a method for camera calibration according to some embodiments of the disclosure. As shown in FIG. 1, the method includes the following actions illustrated in blocks.

At block 101, a camera to be calibrated for performing depth estimation on a scene is determined.

In some embodiments, the camera to be calibrated includes at least one of an coder, a sensor, or an optics component. The optics component is configured to capture the scene, perform light modulation, and perform other operations. The sensor is configured to perform sensor modulation on the signal input into the sensor. The coder is configured to code the input signal. The scene may be any scene that needs depth estimation, for example, a restaurant scene, a classroom scene, a customer scene, or an outdoor street scene. The scene may also be any one of scenes 601 to 604 as shown in FIG. 6. In some embodiments, a sequence of sample images may be added for the scene impulse response by converting a GIF image to still images. The camera to be calibrated for performing depth estimation on the scene may be an iToF camera or a TOF camera, etc., or may be a camera in an electronic device with the iToF function, such as a laptop, a tablet, a desktop computer, or other mobile devices with the iToF function.

In some possible implementations, taking that the camera to be calibrated for performing depth estimation on the scene is an iToF camera as an example, the TOF technology is used to continuously send a light pulse to the target object, and the light returned from the target object is received by a sensor. Flight (round trip) time of the light pulse is detected to determine the distance of the target object. The iTOF camera determines the target distance through detection of the incident and reflected lights. The structure of the iToF camera is shown in FIG. 1B. The iToF camera 12 includes a light source 120, a coder 121, an optics component 122, a sensor 123, a control circuit 124, a processing circuit 125, and etc. A lens is arranged at the front end of the iToF camera chip to collect light. A band pass filter is equipped in the optics component to ensure that light having the same wavelength with that of the light source can enter. Each pixel of the iToF camera records phases of incident and reflected lights between the camera and the object. The signal output by the optics component is transmitted to the sensor including two or more shutters to sample the reflected light at different times. The iToF camera has a large size, for example, about 100 microns (um). The control circuit is configured to control the irradiation unit and the sensor with high-speed signals, so that high depth measurement accuracy can be achieved. The processing circuit is configured to perform data correction and calculation. The distance information can be obtained by calculating the relative phase shift relationship between the incident light and the reflected light.

At block 102, a first correlation function for characterizing a correlation between a sensor modulation signal of the camera to be calibrated and a first modulated light emission signal is determined.

In some embodiments, an entire process of depth estimation performed by the camera to be calibrated is determined; a differentiable function set is used to simulate the entire process and the components involved in the process, for example, different differentiable functions are used to characterize the sensor and the optics component of the camera to be calibrated; and a first correlation function for characterizing the correlation between the sensor and the optics component is determined based on the differentiable functions for characterizing the sensor and the optics component. The correlation between the sensor and the optics component of the camera to be calibrated can be understood as characterizing the correlation between the differentiable function of the sensor and the differentiable function of the optics component. The first correlation function can be understood as an ideal or assumed correlation function obtained by correlation calculation for an ideal signal to be input.

In some possible implementations, the first correlation function may be obtained by the following process.

In step 1, a position relationship between a sensor in the camera to be calibrated and an object to be measured is determined.

Here, the object to be measured is a fixed object in the scene to be estimated, for example, a wall with a known distance. The position relationship includes: vertical facing, back facing, or inclined facing. Taking that the device is an iToF camera as an example, the position relationship between the iToF sensor and a wall at a known distance is determined. The preset condition is the vertical facing, that is, if the sensor is perpendicular to the object to be measured, the first correlation function for characterizing the correlation between the sensor and the optics component is determined.

In step 2, in a case that the position relationship meets the preset condition, the first modulated light emission signal that is emitted by an optics component of the camera to be calibrated, and a reflective signal of the first modulated light emission signal, which is reflected by the object to be detected, are determined.

Here, if the sensor is pointed to the object to be measured, it is determined that the position relationship between the sensor and the object to be measured meets the preset condition. In a specific example, taking that the device is an iToF camera as an example, if the iToF sensor is pointed to a wall at a known distance, it is determined that the position relationship between the iToF sensor and the wall at a known distance meets a preset condition.

In some possible implementations, a differentiable function set for characterizing function components of the camera is determined. Then, in the differentiable function set, a light modulation function for performing light modulation on the signal to be input into the sensor with the optics component is determined.

Here, after the camera for performing depth estimation on the scene is determined, the implementation process of depth estimation by the camera can be obtained based on the identification information of the camera. Each step of the implementation process is simulated or expressed with a differentiable function, that is, a differentiable function set is used to simulate the implementation process.

In some possible implementations, there may be multiple differentiable functions determined at block 102. For example, an iToF camera is used for depth estimation, and the operation process of each component in the iToF camera is simulated by a respective differentiable function, and the differentiable function complies with the hardware restrictions imposed by the simulated component. That is, each of the light source, optics component, the sensor, the control circuit and the processing circuit in the iToF camera and correlations therebetween is simulated by a respective differential function, thereby obtaining a differential iTOF simulation pipeline for depth estimation. In this way, the entire operation process of the camera for depth estimation can be expressed in a differentiable manner, thus enabling presenting the process in a form of a neural network. In the differentiable function set, a first modulated light emission signal for performing light modulation on the signal to be input into the sensor with the optics component is determined.

Here, the signal to be input can be any type of waves, such as a square wave, that is, the waveform to be input into the sensor may be a square wave. Before the square wave is input into the sensor, the light modulation function of the optical component performs light modulation on the square wave, and the first modulated light emission signal for performing light modulation on the square wave is determined.

In step 3, the reflective signal is modulated by using the sensor to obtain the sensor modulation signal.

Here, taking that the signal to be input into the sensor is a square wave as an example, when a square wave is to be input into the sensor, the light modulation function of the optics component is used to perform light modulation on the square wave to obtain the first modulated light emission signal, and then the first modulated light emission signal irradiates the object to be measured to obtain a reflective signal of the object to be measured. Finally, the sensor modulation function is used to perform sensor modulation on the reflective signal to determine the sensor modulation signal.

In step 4, a correlation function of the first modulated light emission signal and the sensor modulation signal is take to be the first correlation function.

Here, the first correlation function is obtained by correlating the first modulated light emission signal and the sensor modulation signal.

The above steps 2 to 4 are to determine the first modulated light emission signal and the sensor modulation signal in the process of performing light modulation on the input signal with the optics component and performing sensor modulation on the reflective signal with the sensor, and then determine a correlation between the first modulated light emission signal and the sensor modulation signal.

At block 103, a second correlation function for characterizing an actual correlation function produced by the camera to be calibrated is determined.

In some embodiments, the second correlation function is a correlation function actually produced after processing the input signal by the camera to be calibrated. That is, the second correlation function is the correlation function produced based on the input signal when the camera to be calibrated is not calibrated; for example, if the input signal is a square wave, then the second correlation function is a correlation function produced by the camera to be calibrated through processing the square wave.

In some possible implementations, the first correlation function and the initial impulse response function are correlated to obtain the second correlation function; the second correlation function may be obtained by the sensor measuring the signal to be input. The second correlation function can be understood as an actual correlation function obtained by calculating the correlation with respect to the actual output signal. In a specific example, since the second correlation function can be obtained by convolving the first correlation function with the impulse response of the sensor, both the first correlation function and the second correlation function may also be known.

At block 104, a calibrated impulse response is determined based on the first correlation function and the second correlation function.

In some embodiments, the assumed impulse response of the sensor represents the difference between the input signal of the sensor and the output signal of the sensor, and the assumed impulse response of the sensor is obtained based on the response of the uncalibrated sensor to the signal to be input.

In some possible implementations, pulse calibration is implemented by deconvolution of the first correlation function and the second correlation function, that is, the above step 104 can be achieved by the following steps S141 and S142 (not shown in the figure):

In step 141, the first correlation function and the second correlation function are deconvolved to obtain a deconvolution result.

In step S142, the deconvolution result is determined as the calibrated impulse response.

Here, since the second correlation function is equal to a convolution of the first correlation function with the impulse response of the sensor, and both the first correlation function and the second correlation function are known, then the unknown calibrated impulse response of the sensor can be obtained by deconvolving the first correlation function with the second correlation function. FIG. 1C is a schematic diagram of the process of calibrating the impulse response according to an embodiment of the disclosure, and the following description will be given in conjunction with FIG. 1C.

The curve 131 represents a measured correlation function, that is, the second correlation function; the curve 132 represents an ideal correlation function, that is, the first correlation function; the curve 133 represents the calibrated impulse response of the sensor. The measured correlation function is equal to a convolution of the ideal correlation function with the unknown calibrated impulse response. Therefore, the calibrated impulse response can be obtained by deconvolving the ideal correlation function with the measured correlation function.

At block 105, the camera to be calibrated is calibrated based on the calibrated impulse response, to obtain the calibrated camera.

In some embodiments, an uncalibrated sensor is used to respond to the input signal to obtain the initial impulse response. The original impulse response is replaced by the calibrated impulse response, or the initial impulse response is adjusted based on the calibrated impulse response, so as to realize the calibration of the camera to be calibrated and obtain the calibrated camera.

In the embodiment of the present application, first, the first correlation function between the sensor modulation signal of the camera to be calibrated and the first modulated light emission signal, and the second correlation function actually produced by the camera to be calibrated are determined; then the calibrated impulse response is determined based on the first correlation function and the second correlation function. In this way, by calibrating the assumed impulse response of the sensor, the process of calibrating the coder in the camera is omitted. Finally, the camera to be calibrated is calibrated based on the calibrated impulse response to obtain the calibrated camera. Therefore, by calibrating the impulse response of the sensor, the error in the depth estimation of the camera can be eliminated, and no further calibration is needed in the subsequent use of the camera, which simplifies the entire implementation process.

In some embodiments, in order to improve the accuracy of depth estimation of the scene to be estimated, the calibrated camera is used to perform depth estimation on the scene based on the calibrated impulse response to obtain the scene depth.

Here, the scene to be estimated may be a current scene collected by the device, or a received scene sent by other devices, or a scene stored locally. The assumed impulse response of the sensor in the calibrated camera is the calibrated impulse response. The calibrated impulse response is applied to the sensor of the calibrated camera, and the calibrated camera is used to estimate the depth of the scene to be estimated, which not only omits the process of calibrating the output of the coder of the camera, but also improves accuracy of the depth estimation of the calibrated camera.

In some embodiments, in order to ensure that the measured correlation is consistent with the correlation calculated based on the calibrated impulse response, the determined calibrated impulse response is continuously updated until the calibrated impulse response is consistent with all the acquired correlations. That is, after determining the calibrated impulse response, the following actions are performed.

In step 1, the current frequency of the first modulated light emission signal is changed to obtain a second modulated light emission signal.

Here, the current frequency of the signal input into the camera to be calibrated is determined, which may be the transmitting frequency of the signal. For example, the signal is a square wave, and the square wave is transmitted at a frequency of 20 megahertz (MHz), the current frequency of the square wave is 20 MHz. By using the current frequency of the first modulated light emission signal, the adjusted light emission signal emitted by the optics component of the camera to be calibrated at a different frequency, i.e., the second modulated light emission signal, is obtained. The current frequency of the first modulated light emission signal is the frequency at which the sensor operates. When the camera performs depth estimation, the modulation and demodulation frequency is used as the frequency for calibrating the impulse response of the sensor. For example, if two modulation and demodulation frequencies of 20 MHz and 100 MHz are used in the camera for depth estimation, the frequencies used to calibrate the impulse response of the sensor are 20 MHz and 100 MHz. In this way, the effectiveness of using the calibrated impulse response can be guaranteed. properties, thereby reducing the depth error of the depth estimation performed by the camera.

In step 2, a third correlation function for characterizing a correlation between the sensor modulation signal of the camera to be calibrated and the second modulated light emission signal is determined.

Here, the implementation manner of step 2 is the same as the implementation manner of the foregoing step 102, that is, the third correlation function is obtained by correlating the second modulated light emission signal with the sensor modulation signal of the camera to be calibrated. The third correlation function can be understood as being obtained by phase scanning of the sensor on the object to be measured according to different frequencies.

In step 3, a fourth correlation function for characterizing an actual correlation function produced by the camera to be calibrated with the second modulated light emission signal is determined.

Here, the fourth correlation function is the actual correlation function produced, by the camera to be calibrated, with the second modulated light emission signal.

In step 4, another calibrated impulse response is determined based on the third correlation function and the fourth correlation function.

Here, the another calibrated impulse response is obtained by deconvolution of the third correlation function and the fourth correlation function.

In step 5, the calibrated impulse response is updated based on the another calibrated impulse response.

Here, first, the impulse response determined at the previous frequency of the changed frequency is adjusted based on the signal expression at any changed frequency and the first correlation function at the frequency, to obtain an updated calibrated impulse response at the frequency. Then, if the difference between the convolution result of the updated calibrated impulse response with the first correlation function and the measured second correlation function is less than or equal to the preset difference, then the updated calibrated impulse is used as the final calibrated impulse response of the sensor. If the difference between the convolution of the updated calibrated impulse response with the first correlation function and the measured second correlation function is greater than the preset difference, the updated calibrated impulse response obtained at the changed frequency is adjusted again by using the signal expression at the next preset frequency of the changed frequency and the first correlation function, to obtain the further updated calibrated impulse response.

In some possible implementations, for different frequencies, each time the third correlation function at a frequency is obtained, the calibrated impulse response at the previous frequency of the frequency is convolved with the first correlation function to obtain the first convolution result; then, the difference between the obtained convolution result and the third correlation function is compared to adjust the calibrated impulse response of the previous frequency, to obtain the calibrated impulse response at the frequency, which is used for calculation of the convolution result at the next frequency. Finally, based on the first convolution result and the third correlation function, the calibrated impulse response is adjusted to obtain an updated calibration impulse response.

In some embodiments, for the third correlation function at each frequency, the third correlation function at the current frequency is compared with the convolution result obtained by convolving the impulse response determined at the previous frequency with the first correlation function, the impulse response determined at the previous frequency is adjusted based on the difference to obtain an updated calibrated impulse response. In this way, the operations are performed repeatedly until the obtained convolution result is consistent with the third correlation function.

In the embodiment of the present disclosure, the reason for the difference between the signal input to the sensor and the output signal of the sensor can be determined, so that the impulse response of the sensor can be recovered perfectly by calibrating the impulse response of the sensor; and the calibrated impulse response can be applied to the process of optimizing the coding function. Therefore, calibration of the coding function may be omitted, and the accuracy of depth estimation is improved.

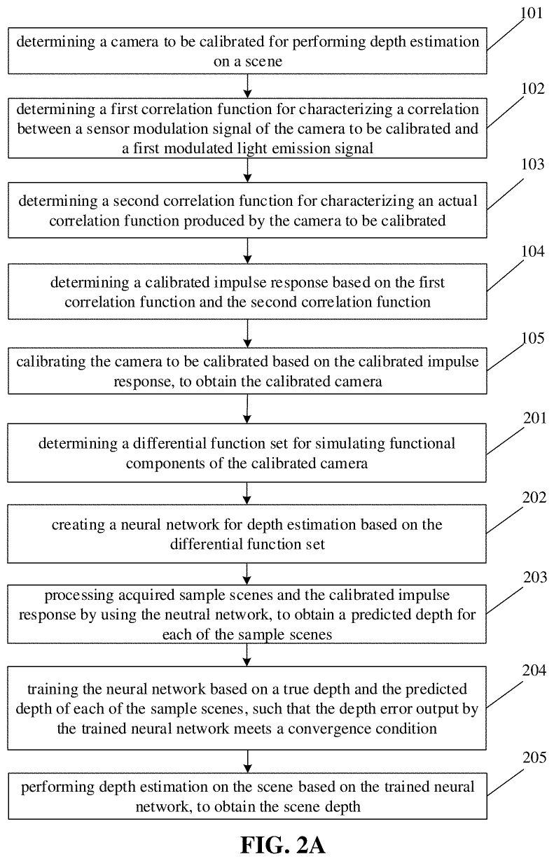

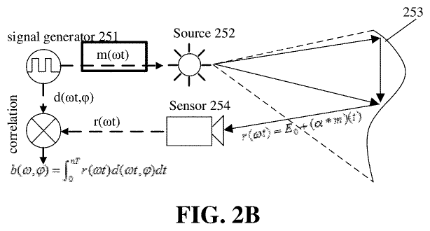

In some embodiments, after the impulse response of the sensor is calibrated, the calibrated impulse response is used in training of the neural network built based on a differentiable function set, to automatically optimize the target differentiable function in the neural network. Finally, depth estimation is performed by the camera loaded with the optimized target differentiable function, to improve the accuracy of depth estimation of the camera. After the step 105, the method further includes steps as shown in FIG. 2A. FIG. 2A is a flow chart of another method for camera calibration according to the embodiment of the disclosure. The steps will be described in below in conjunction with FIG. 2A and FIG. 1A.

At block 201, a differentiable function set for simulating functional components of the calibrated camera is determined.

In some embodiments, the functional components of the calibrated camera at least include: sensors, an optics component and a coder, the process of depth estimation of each functional component in the calibrated camera is simulated, and it is ensured that each step of the simulation is differentiable.

In some possible implementations, first, a simulation function set for simulating functions of the sensor, the optics component and the coder of the calibrated camera are determined.

Here, the function of each component in the calibrated camera, i.e., the sensor, the optics component and the coder, is characterized by a simulation function, so that the entire process of depth estimation by each functional component is simulated by using a simulation function. In a specific example, taking the device as an iToF camera as an example, the simulation function for realizing the function of the iToF camera includes the simulation function for realizing the function of each component in the iToF camera.

Second, differentiability of each of simulation functions in the simulation function set is determined.

Here, it is determined whether the simulation function in the simulation function set satisfies the differential condition. The differential condition means that the simulation function is continuous at a point. If the simulation function is a multivariate function, it is required that the first-order partial derivative of the point exists. If the simulation function satisfies the differential condition, it means that the simulation function is differentiable, and if the simulation function does not satisfy the differential condition, it means that the simulation function is not differentiable.

Finally, in the case that the differentiability of the simulation function does not meet a differential condition, a differentiable function that matches the simulation function is determined, to obtain the differentiable function set.

Here, if the differentiability does not meet the differential condition, that is, the simulation function is not differentiable, then a differentiable function is used to approximate the simulation function, that is, a differentiable function (i.e., a differentiable approximation) similar to the simulation function is determined, to obtain the simulation function set.

In some possible implementations, in the case that the differentiability does not meet the differential condition, a differentiable function of which similarity with the simulation function is greater than or equal to a preset similarity threshold is determined. For example, in the case that the simulation function is not differentiable, a differentiable function of which similarity with the simulation function is greater than or equal to the similarity threshold is constructed, or a differentiable function library is searched for a function of which similarity with the simulation function is greater than or equal to the similarity threshold, to obtain a differentiable function that can implement the function of the corresponding component of the simulation function. In this way, the differentiable representation of the entire depth estimation process of the camera is realized. By representing the depth estimation process with simulation functions, and for the non-differentiable simulation function, a similar differentiable function is used, so that the entire depth estimation pipeline represented in a differentiable manner is embedded in the neural network.

In step 202, a neural network for depth estimation is created based on the differentiable function set.

In some embodiments, after obtaining the differentiable function set for simulating the depth estimation process performed by the calibrated camera, a neural network for implementing the process is created based on the differentiable function set. In some possible implementations, the neural network may be consisted of the differentiable functions (for example, light source modulation function/demodulation function in the coder in the software/optics point spread function) with learnable parameters, as well as an application neural network if available, such that the trained neural network may be used for depth estimation, 3d object recognition, etc. Taking that the device is an iToF camera as an example, the differentiable function set includes a function for simulating the optics component, a function for simulating the sensor, a function for simulating the control circuit, and a function for simulating the processing circuit. The neural network may be created based on these functions and the correlations between these functions. For example, in the neural network, the layer of the differentiable function of the optics component is located before the layer of the differentiable function of the sensor; and the layer of the differentiable function of the sensor is located before the layers of the differentiable functions corresponding to the control circuit and the processing circuit, and so on. The created neural network can represent the entire process of depth estimation of the scene performed by the device.

In some possible implementations, the neural network includes at least a coding module, an optics module and a sensor module.

The coding module is determined based on a differentiable function of the coder; here, a differentiable function capable of simulating the coder is used to realize the coding module. In this way, the coding module can realize the function of the coder.

The optics module is determined based on a differentiable function of the optics component; an output of the coding module is an input of the optics module; here, the differentiable function simulating the optics component is used to realize the optics module. In this way, the optics module can realize the function of the optics component.

The sensor module is determined based on a differentiable function of the sensor; an output of the optics module is an input of the sensor module. Here, the differentiable function simulating the sensor is used to realize the sensor module. In this way, the sensor module can realize the function of the sensor.

In other embodiments, the neural network may further include an application module for performing task processing on a preset task based on the output result of the sensor module to obtain a processing result.

In this way, based on the differentiable functions simulating the device's entire operation process of depth estimation of the scene, a neural network including the differentiable functions and the correlations between multiple differentiable functions is created, so that the differentiable functions can be automatically optimized by training the neural network.

At block 203, acquired sample scenes and the calibrated impulse response are processed by using the neural network, to obtain a predicted depth for each of the sample scenes.

In some embodiments, before training the neural network, a sample scene and the calibrated impulse response are obtained. The calibrated impulse response is obtained by calibrating the impulse response of the sensor in the device. The sample scene may be generated by rendering the sample scene according to a time sequence, that is, a simulated scene is generated by using a time-resolved transient rendering program. Alternatively, the sample scene may be a scene selected randomly from a preset sample scene library. The sample scene may be a collection of images rendered over time, that is, the images in the rendered image collection change over time. Each pixel in the sample scene has a corresponding time-resolved transient impulse response of the light transport. The calibrated impulse response is used to characterize the difference between the input and output of the sensor in the camera. In the embodiments of the disclosure, the calibrated impulse response may be obtained by analyzing the input signal and output signal of the sensor and calibrating the assumed impulse response of the sensor.

The transient impulse response of each pixel in the sample scene, other parameters of the sensor, and the calibrated impulse response are used as input of the neural network to obtain the depth of the sample scene predicted by the neural network. The calibrated impulse response can be used as one of the sensor parameters, and other sensor parameters include: noise parameter, optics parameter, and required depth range. The process flow of the input by the neural network is determined based on the process of depth estimation on the sample scene performed by the device. For example, the transient impulse response of each pixel in the sample scene is input into a layer corresponding the coding function in the neural network layer, an output of the layer is input to another layer corresponding to the optics function in the neural network, to obtain an optics output result, and the optics output result and the calibrated impulse response are input to a network layer corresponding the sensor function in the neural network, to obtain a predicted depth of the sample scene through depth estimation on the sample scene by the neural network.

At block 204, the neural network is trained based on a true depth and the predicted depth of each of the sample scenes, such that a depth error output by the trained neural network meets a convergence condition.

In some embodiments, the differentiable functions in the created neural network are trained by using actual depths and predicted depths of sample scenes, such that the depth error output by the trained neural network meets the convergence condition. Here, the training may be performed on the parameters of all differentiable functions in the neural network, or may be performed on the parameters of some of the differentiable functions in the neural network.

In some possible implementations, the depth of the sample scene is estimated by the neural network, to obtain a predicted result, and the predicted result is compared with an actual value of the sample scene, to obtain the depth error of the scene depth. The target differentiable function in the neural network can be adjusted based on the depth error, to obtain the trained neural network. For example, taking that the device is an iToF camera as an example, the differentiable function of the coder in the camera i.e., the coding function, is trained, so that the trained optimized coding function can reduce the depth error. In this way, by training the parameters of the coding function in the neural network, the differentiable function of the coder is automatically optimized, and the optimized parameters are applied to the coder, thereby improving the accuracy of the depth estimation performed by the device.

At block 205, depth estimation is performed on the scene based on the trained neural network, to obtain the scene depth.

In some embodiments, depth estimation is performed on the scene to be estimated by using a neural network including optimized differentiable function, to obtain the depth of the scene. The scene to be estimated may be a scene collected by the device currently, a scene received from another device, or a scene stored at the device locally.

In some possible implementations, in the process of training the neural network, the parameters for training all functional components may be trained, or the parameters for training some functional components may be trained. Take the parameters of training some functional components as an example, such as performance parameters of the optics component and the sensor, which may be set values. A differentiable function optimized through training of the neural network may be applied to the component simulated by the function, to optimize the performance of the device. For example, for a coder of an iToF camera, a differentiable function simulating the coder, i.e., a coding function, is determined, and a neural network including the coding function is created, and then trained to automatically optimize the coding function. The optimized coding function is applied to the coder to reduce the multi-path interference generated when the iToF camera performs depth estimation and reduce the depth error. For another example, taking an optics component of an iToF camera as an example, a differentiable function simulating the optics component, i.e., an optics function, is determined, and a neural network that includes the optics function is created, and then trained to automatically optimize the optics function, the optimized optics function is applied into the optics component, to reduce the multi-path interference generated when the iToF camera performs depth estimation and reduce the depth error.

In the embodiment of the disclosure, the entire process of depth estimation performed by the calibrated camera is simulated, and each step in the process is differentiable, so that the process can be built in a neural network; further, by training the neural network, the differentiable function(s) in the process can be optimized automatically, thus improving the accuracy of depth estimation in the entire process and reducing multi-path interference.

In some embodiments, the camera is optimized by applying the optimized differentiable function(s) in the trained neural network to the functional component(s) of the camera, so that the optimized camera is used for depth estimation of the scene to be estimated, and accuracy of the depth estimation is improved. That is, the above step 205 can be implemented through the following steps 251 to 254 (not shown in the figure):

In Step 251, an optimized differentiable function is determined in the trained neural network.

Here, in the trained neural network, an optimized differentiable function of each functional component of the camera is determined, and a plurality of optimized differentiable functions are obtained.

In Step 252, a functional component to be optimized is determined from functional components simulated by the optimized differentiable functions.

Here, the functional component to be optimized can be determined based on the optimized differentiable functions. In this way, the functional component simulated by the optimized differentiable function is the functional component to be optimized; or one or more functional components are arbitrarily selected from the functional components simulated by the optimized differentiable functions as the functional component(s) to be optimized.

In Step 253, one or more parameters of the functional component to be optimized are adjusted based on the optimized differentiable function corresponding to the functional component to be optimized to obtain an optimized functional component.

Here, the parameters of the actual functional component to be optimized are adjusted according to the optimized differentiable function simulating the functional component to be optimized, to realize the optimization process of the functional component to be optimized to obtain the optimized functional component. The optimized functional component includes at least one of a coder, an optical component, or a sensor.

In Step 254, depth estimation is performed on the scene to be estimated by using the camera with the optimized functional component(s) to obtain the scene depth.

Here, the optimized functional component(s) of the camera include(s) at least one of an optimized coder, an optics component or a sensor. In this way, depth estimation is performed on the scene to be estimated by using the camera including the optimized functional component(s), which can not only reduce the influence of multipath interference, but also improve the accuracy of the obtained scene depth.

In the following, an exemplary application of the embodiment of the disclosure in an actual application scenario will be described, and the description will be made by taking an iToF camera to perform depth estimation on a fixed scene as an example.

In the related technologies, ToF imaging is suitable for many emerging 3D computer vision applications, such as virtual reality/augmented reality (AR/VR), robot, and autonomous car navigation. An iToF camera (such as Microsoft Kinect) measures depth indirectly by using a periodic continuous light signal to illuminate the scene and measure the phase shift of the returned signal. For mobile applications, iToF cameras have become the core depth sensing technology due to low cost, low power consumption and compact size. Although iToF sensors have many advantages, there are still problems of low signal-to-noise ratio (SNR) and multi-path interference (MPI) in actual operation. For example, ToF depth maps have low SNR in low reflectivity or long-distance target areas. In addition, the ToF depth map is prone to present incorrect depths at positions where there is multi-path interference in the optical signal returned to the sensor.

To facilitate the understanding of the embodiments of the disclosure, the operating principle of the ToF sensor is described hereinafter.

FIG. 2B is a schematic diagram of the operating principle of the ToF sensor according to some embodiments of the disclosure, and the following description will be made with reference to FIG. 2B.

In step 1, a signal is generated by a signal generator 251.

The signal generator 251 may generate, e.g., a square wave signal, and modulate the square wave signal with a modulation function d(ωt,φ).

In step 2, a light signal is generated by a light source 252.

Here, the light signal generated by the light source 252 is modulated with a light modulation function m(ωt).

In step 3, the modulated light signal is received by a lens assembly 253 which reflects or refracts the received modulated light signal, and transmits it to a sensor 254.

Here, the light signal r(ωt) that arrives on a pixel of the sensor 254 is the convolution of the scene impulse response α(t) for the point that the pixel is imaging, where r(ωt) be obtained with an equation r(ωt)=E₀+(α*m)(t), α(t) represents the input of the simulation pipeline for implementing the iTOF sensor, and E₀ represents a set initial value. The light signal r(ωt) is correlated with the modulation function d(ωt,φ).

In step 4, the correlation of the light signal r(ωt) and the modulation function d(ωt,φ) is integrated for a fixed exposure time, by using the equation b(ω,φ)=∫₀^{nT}r(ωt)d(ωt,φ)dt. This results in the brightness of the scene measured by the camera.

The above four steps are repeated k times for k different pairs of d(ωt,φ) and m(ωt), to find the optimal d(ωt,φ) and m(ωt).

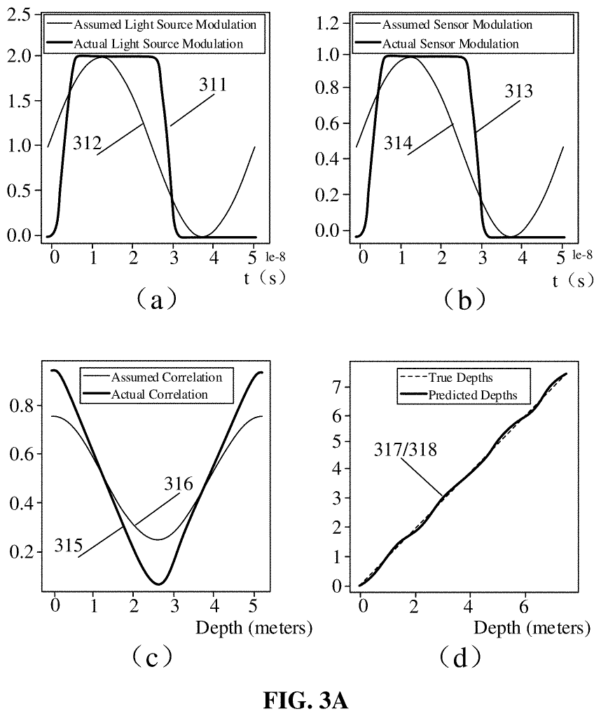

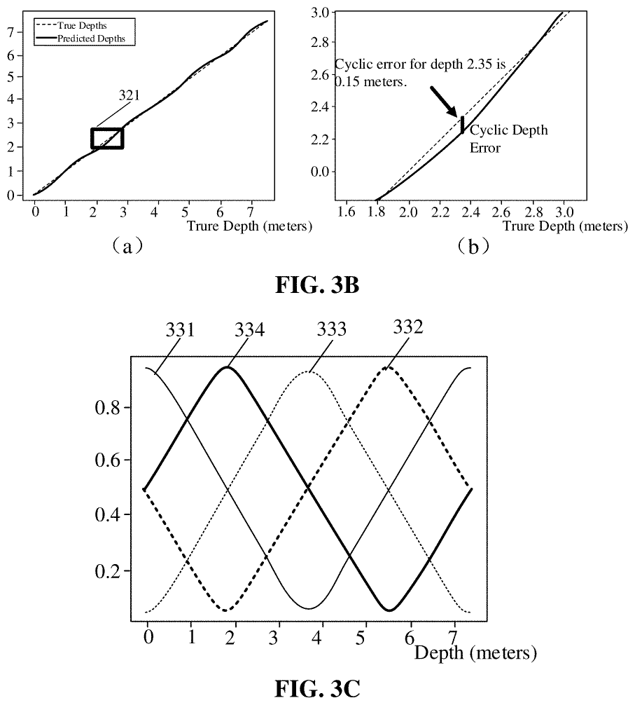

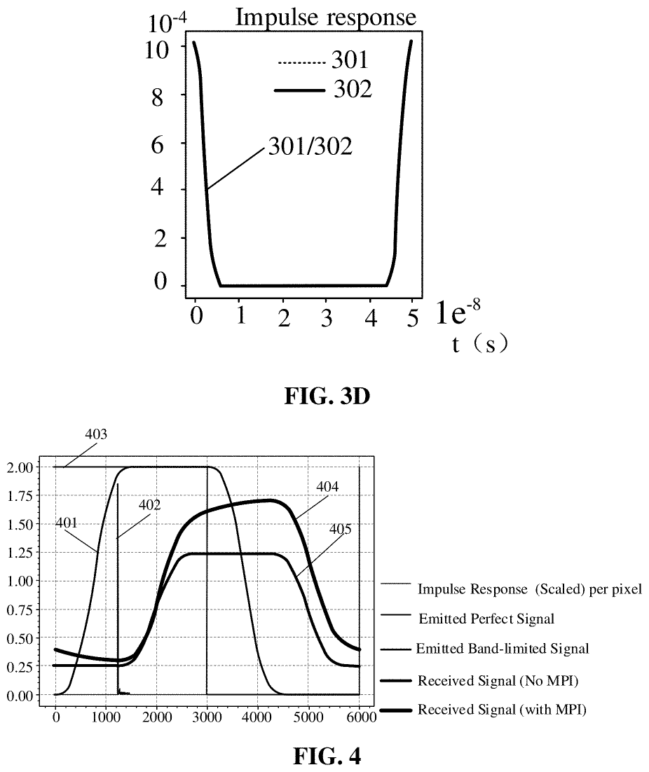

In some embodiments, mismatch between the assumed functions used for light source modulation and sensor demodulation, and the actual functions produced by the hardware exists. If the mapping of brightness measurements to depth is done using the assumed functions, then a cyclic error in the recovered depth will be resulted as illustrated FIG. 3A. FIG. 3A is a schematic diagram of a simulation result of the method for camera calibration according to an embodiment of the disclosure. The following description will be made in conjunction with FIG. 3A, in which:

Graph (a) of FIG. 3A shows the simulation result of the light modulation function, where the simulation curve 311 represents the actual light modulation function, and the simulation curve 312 represents the assumed light modulation function.

Graph (b) of FIG. 3A shows the simulation result of the sensor demodulation function, where the simulation curve 313 represents the actual sensor demodulation function, and the simulation curve 314 represents the assumed sensor demodulation function.

Graph (d) of FIG. 3A shows the simulation result of the convolution function, where the simulation curve 315 represents the actual convolution function, and the simulation curve 316 represents the assumed convolution function.

Graph (d) of FIG. 3A shows the simulation result of the depth range, where the simulation curve 317 represents the estimated depth, and the simulation curve 318 represents the actual depth.

In some embodiments, the above-mentioned cycle error can be calibrated in one of the following two methods.

Method 1: The cycle error is solved by measuring the cycle error and obtaining the mapping from the measured depth to the true depth. The simulation result is shown in FIG. 3B. FIG. 3B is a schematic diagram of a simulation result of the cycle calibration according to an embodiment of the disclosure. In FIG. 3B, graph (a) of FIG. 3B shows the correspondence relationship between the true depth and the estimated depth in the range of 1 to 7 meters, and graph (b) of FIG. 3B shows the correspondence relationship between the true depth and the estimated depth in the area 321, where, cyclic error for depth 2.35 is 0.15 meters. If predicted depth is 2.2 then add an offset of 0.15. It can be seen from the graph (b) of FIG. 3B that after the cyclic calibration is performed in this way, there is still a certain difference between the true depth and the estimated depth.

Method 2: the modulation, demodulation and correlation functions are not assumed. The actual correlation functions are measured, and are used, by taking account of variations in albedo and ambient light for a scene point, as a look-up table to map brightness measurements to depths. In this method, an algorithm that applies a simple transformation to the correlation functions is used, as a look-up table that is invariant to albedo and ambient light. As shown in FIG. 3C, FIG. 3C is a schematic diagram of a simulation result of the measured correlation function and the lookup table according to this method, where the abscissa represents the depth value, and the ordinate represents the measured brightness value; curve 331 represents a simulation result of the true depth, curve 332 represents the simulation result of the estimated depth, and curve 333 represents the simulation result of the received signal without considering MPI, and the curve 334 represents the simulation result of the impulse response per pixel of the scene.

As can be seen from the above method 1 and method 2, both the two described cyclic calibration methods are frequency dependent. This means that the cyclic calibration needs to be done every time you want to configure a different frequency in the ToF camera. Therefore, the implementation process is complicated.

In view of this, an embodiment of the disclosure provides a method for camera calibration. A physically accurate differentiable iToF simulation pipeline (corresponding to the entire process of depth estimation performed by the device in the above embodiment) is used to build a neural network that implements the pipeline, an actual impulse response of the iToF sensor may be obtained with the calibration method of the embodiment of the disclosure, the impulse response can be applied to the process of the depth estimation of the iToF camera, thereby avoiding the subsequent calibration of the estimation result during the process of depth estimation of the iToF camera, which simplifies the whole implementation process. Further, the coding function of iTOF in the neural network may be optimized, so as to recover a higher fidelity depth map with higher SNR, and the MPI error may be reduced.

In the embodiment of the disclosure, the depth estimation of the scene includes two stages: the first stage is to calibrate the assumed impulse response of the sensor, and the second stage is to optimize the coding function in the neural network that implements the depth estimation. Among them, the implementation process of the calibration of the assumed impulse response of the sensor includes the following actions.

In step 1, the iToF sensor is pointed to a wall at a known distance.

In step 2, a set square light modulation function and a sensor modulation function are input into the iToF sensor.

In step 3, phase shift is performed to reconstruct a completed correlation function C(t) (which may correspond to the third correlation function and the second correlation function in the above embodiment).

In step 4, the correlation function acquired in step 3 is related to the input square wave (corresponding to the signal to be input in the above embodiment) to acquire correlation C(t):

C(t)=corr(m(t),d(t))*h(t) (1)

where C(t) is the acquired correlation, m(t) is the light modulation function, d(t) is the sensor modulation function, corr( ) is the correlation operator between 2 signals (corresponding to the first correlation function in the above embodiment), * is convolution, and finally h(t) is the unknown impulse response (corresponding to the assumed impulse response of the sensor in the above embodiment)

The third correlation function C(t) acquired for square functions at different repetition frequencies.

In some possible implementations, the third correlation function C(t) is acquired at the repetition frequency at which the iToF sensor will be operated.

In step 6, after obtaining h(t), it is substituted into formula (1), and the difference between the obtained value and the measured C(t) is determined, and h(t) is updated based on the difference. In this way, C(t) and corr(m(t),d(t)) are known, h(t) is solved, for each frequency, it is ensured that the obtained result is as close to the measured C(t) as possible, so that the calibration effect of the final calibrated impulse response is better.

Through the above steps 1 to 6, the calibration of the impulse response is completed. The calibrated impulse response is input as the parameters of the iToF sensor to the second stage, that is, the calibrated impulse response is used as the input of the neural network that optimizes the coding function. Thus, the performance of the optimized coding function is better. FIG. 3D is a schematic diagram of the simulation result of the calibrated impulse response according to the embodiment of the disclosure. As shown in FIG. 3D, the curve 301 represents the actual impulse response, and the curve 302 represents the restored impulse obtained by deconvoluting the received waveform with the waveform assumed to be sent, i.e., restored impulse response (corresponding to the calibrated impulse response in the above-mentioned embodiment), where the peak occurs at the time 0. It can be seen from FIG. 3D that the restored impulse response and the actual impulse response fit perfectly, i.e., the calibration of the impulse response implemented through the above steps 1 to 6 has a high accuracy.

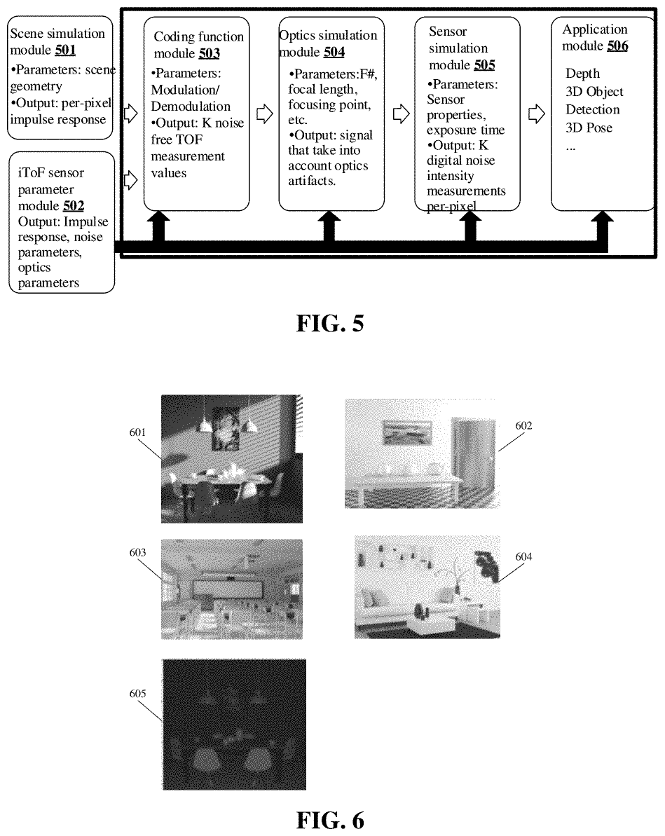

The implementation process of stage two is shown in FIG. 5. FIG. 5 is a schematic diagram of the implementation framework of the iToF simulation pipeline according to some embodiments of the disclosure. The following description will be made in conjunction with the description shown in FIG. 5. The iToF simulation pipeline includes a scene simulation module 501, an iToF sensor parameter module 502, and a coding function module 503, an optics simulation module 504, and a sensor simulation module 505.

The scene simulation module 501 is configured to generate a simulated scene using a time-resolved transient rendering program.

In the scene simulation module 501, the impulse response of each pixel is a scene impulse response of the pixel. The input parameter is the geometric scene, and the output is the impulse response of each pixel. In some possible implementations, a simulated scene rendered by a time-resolved transient rendering program is used, which can ensure that each pixel in the simulated scene has a corresponding time-resolved pulse/transient response of light transmission.

The simulated scene is shown in FIG. 6, which is a schematic diagram of an application scenario of the method for camera calibration according to some embodiments of the disclosure. Scenes 601 to 604 represent generated different simulated scenes. Taking scene 601 as an example, the depth map generated for scene 601 is shown in picture 605.

The iToF sensor parameter module 502 is configured to use iToF sensor parameters (noise parameters, optics parameters, required depth range) and the impulse response obtained in stage one as inputs of the iToF simulation pipeline.

Outputs of the iToF sensor parameter module 502 include the impulse response, noise parameters and optics parameters. In the iToF sensor parameter module 502, the impulse response is a device impulse response. The demodulation/modulation functions are the learnable parameters in the neural network.

The coding function module 503 is configured to convolve the light modulation and sensor demodulation function with the impulse response of each pixel of the simulated scene. K iterations are performed on the convolution result, to output K noise-free ToF measurements. The coding function module 503 may include K demodulation/modulation functions.

The input of the coding function module 503 is a modulation/demodulation function, and the output of the coding function module 503 is K noise-free ToF measurement values.

In some possible implementations, the impulse response of each pixel of the simulated scene is shown by curve 402 in FIG. 4. In FIG. 4, curve 403 represents the ideal square wave to be actually input, that is, the transmitted ideal waveform, and curve 401 is the actual waveform after the ideal square wave is output from the sensor, that is, the transmitted band-limited waveform. The curve 404 represents the waveform with MPI being considered, obtained by convolution of the ideal square wave with h(t) Curve 405 represents the waveform without MPI being considered, obtained by convolution of an ideal square wave with h(t).

In some embodiments, before optimizing the coding function in the neural network, many time-resolved scenes are simulated, and the iToF sensor parameters in the scenes are obtained. In the process of optimizing the coding function in the neural network, the time-resolved scene simulation, ground truth and iToF sensor parameters are input into the neural network. In the neural network, for each input time-resolved pixel, the depth error is calculated, and then propagated backward to update the coding function until the network parameters of the neural network converge, thereby obtaining the neural network including the optimized coding function. Therefore, after optimizing the coding function, the neural network can be loaded into the iToF camera to capture the iToF measurements, and a depth estimation algorithm as same as that used in the process of optimizing the coding function is used for performing depth estimation on the current scene.

The optics simulation module 504 is configured to simulate how the optics parameters change the ToF measurement, given the optics parameters of the iToF module.

The parameters input into the optics simulation module 504 include F factor (that is, F #, which is the ratio of the focal length to the entrance pupil diameter), focal length and focus, etc., and the output of the optics simulation module 504 is a signal including optics artifacts.

The sensor simulation module 505 is configured to perform ToF measurement on the simulated scene and scale the measurement according to sensor parameters (for example, quantum efficiency and exposure time, etc.). Finally, analog-to-digital conversion is performed on the scaling result.

The parameters input into the sensor simulation module 505 include sensor attributes and exposure time, etc., and the output of the sensor simulation module 505 is K measurements of digital noise intensity for each pixel.

The application module 506 is configured to perform 3D reconstruction, 3D object detection, 3D posture detection, augmented reality, etc., by using a neural network having an optimized coding function.

Each function in the iToF simulation pipeline shown in FIG. 5 is a differentiable function, so that a neural network can be built based on the iToF simulation pipeline, and the differentiable function can be optimized by training the neural network. For example, the coding function in the iToF simulation pipeline can be optimized automatically by training the neural network.

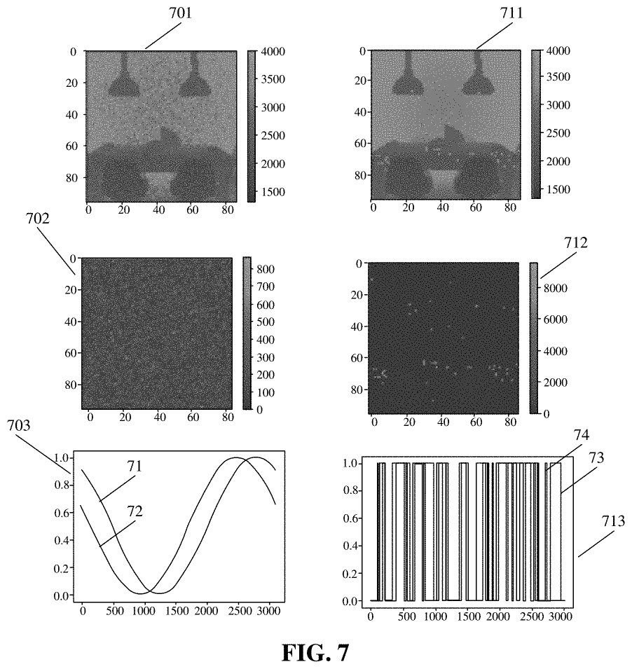

Through the above modules, the process of optimizing the coding function of the entire neural network is realized. First, the differentiable iToF simulation framework and the differentiable depth estimation algorithm are realized. Then, in the process of optimizing the coding function, the time-resolved rendered image and the ground true depth are taken as inputs, the depth error is calculated, and the coding function is adjusted according to the output gradient, to optimize the coding function; finally, in the testing phase, the neural network including the optimized coding function is used to obtain the iToF measurement, the same depth estimation algorithm used during the training of the neural network is used to decode the depth data. In this way, the differentiable iToF simulation pipeline and the differentiable depth estimation algorithm are used to optimize the coding function of iToF; the depth estimation is performed based on the neural network including the optimized coding function, which can reduce the depth error caused by the MPI in the input optical signal, and can reduce the depth error caused by noise. Taking the depth estimation for the scene 601 in FIG. 6 as an example, the estimation result is shown in FIG. 7. FIG. 7 is a schematic diagram of the application scenario of the method for camera calibration according to some embodiments of the disclosure, and the following description is made in conjunction with FIG. 7:

Picture 701 represents the depth map obtained by performing depth estimation for the scene 601 in FIG. 6 without using the method for camera calibration according to the embodiment of the disclosure. Picture 702 is a complete absolute depth error of picture 701, and picture 703 indicates a demodulation code used in the process of obtaining the picture 701, where the waveform 71 represents an ideal demodulation code, and the waveform 72 represents the demodulation code actually used.

Picture 711 represents the depth map obtained for the scene 601 in FIG. 6 by using the method for camera calibration according to the embodiment of the disclosure, and the picture 712 is the complete absolute depth error of the picture 711. Picture 713 represents the demodulation code used in the process of obtaining the picture 711, where the waveform 73 represents the ideal demodulation code, and the waveform 74 represents the demodulation code actually used.

In FIG. 7, the depth error corresponding to the picture 701 is 169.33 millimeters (mm), and the depth error corresponding to the picture 711 is 86.43 mm. By comparing the picture 701 and the picture 711 horizontally, it can be seen that the depth map obtained by using the method for camera calibration according to the embodiment of the disclosure has less noise and less multi-path interference. In addition, by comparing the depth error corresponding to the picture 701 and the depth error corresponding to the picture 711, it can be seen that the depth error of the depth map obtained by using the method for camera calibration according to the embodiment of the disclosure is significantly smaller.

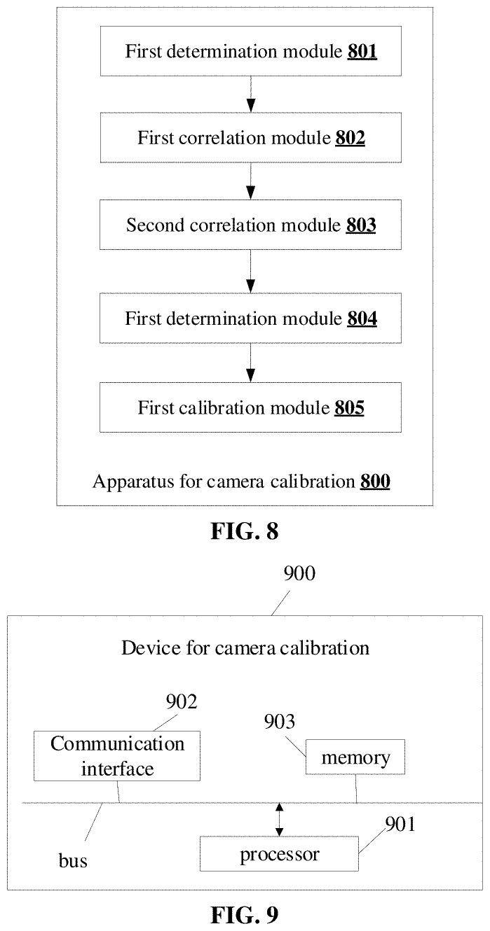

An embodiment of the disclosure provides an apparatus for depth estimation. FIG. 8 is a block diagram of a device for depth estimation according to some embodiments of the disclosure. As shown in FIG. 8, the device 800 includes a first determination module 801, a first correlation module 802, a second correlation module 803, a second determination module 804, and a first calibration module 805.

The first determination module 801 is configured to determine a camera to be calibrated for performing depth estimation on a scene.

The first correlation module 802 is configured to determine a first correlation function for characterizing a correlation between a sensor modulation signal of the camera to be calibrated and a first modulated light emission signal.

The second correlation module 803 is configured to determine a second correlation function for characterizing an actual correlation function produced by the camera to be calibrated.

The second determination module 804 is configured to determine a calibrated impulse response based on the first correlation function and the second correlation function.

The first calibration module 805 is configured to calibrate the camera to be calibrated based on the calibrated impulse response, to obtain the calibrated camera.

In some embodiments, the apparatus further includes a first estimation module, configured to perform depth estimation on the scene based on the calibrated impulse response by using the calibrated camera, to obtain a scene depth.

In some embodiments, the first correlation module 802 includes a first determination sub-module, a second determination sub-module, a first modulation sub-module and a third determination sub-module.

The first determination sub-module is configured to determine a position relation between a sensor in the camera to be calibrated and an object to be detected.

The second determination sub-module is configured to, in response to the position relation meeting a preset condition, determine the first modulated light emission signal that is emitted by an optics component of the camera to be calibrated, and a reflective signal of the first modulated light emission signal, which is reflected by the object to be detected.

The first modulation sub-module is configured to modulate the reflective signal by using the sensor, to obtain the sensor modulation signal.

The third determination sub-module is configured to take a correlation function of the first modulated light emission signal and the sensor modulation signal to be the first correlation function.

In some embodiments, the second determination module 804 includes a first deconvolving sub-module and a fourth determination sub-module.

The first deconvolving sub-module is configured to deconvolve the first correlation function and the second correlation function to obtain a deconvolution result.

The fourth determination sub-module is configured to determine the deconvolution result as the calibrated impulse response.

In some embodiments, the apparatus further includes a first obtaining module, a third determination module, a fourth determination module, a fifth determination module, and a first update module.

The first obtaining module is configured to change a current frequency of the first modulated light emission signal to obtain a second modulated light emission signal.

The third determination module is configured to determine a third correlation function for characterizing a correlation between the sensor modulation signal of the camera to be calibrated and the second modulated light emission signal.

The fourth determination module is configured to determine a fourth correlation function for characterizing an actual correlation function produced by the camera to be calibrated with the second modulated light emission signal.

The fifth determination module is configured to determine another calibrated impulse response based on the third correlation function and the fourth correlation function.

The first update module is configured to update the calibrated impulse response based on the another calibrated impulse response.

In some embodiments, the first estimation module includes a fifth determination sub-module, a first creation sub-module, a first processing sub-module, a first training sub-module, and a first estimation sub-module.

The fifth determination sub-module is configured to determine a differentiable function set for simulating functional components of the calibrated camera.

The first creation sub-module is configured to create a neural network for depth estimation based on the differentiable function set;

The first processing sub-module is configured to process acquired sample scenes and the calibrated impulse response by using the neural network, to obtain a predicted depth for each of the sample scenes.

The first training sub-module is configured to train the neural network based on a true depth and the predicted depth of each of the sample scenes, such that a depth error output by the trained neural network meets a convergence condition.

The first estimation sub-module is configured to perform depth estimation on the scene based on the trained neural network, to obtain the scene depth.

In some embodiments, the functional components of the calibrated camera at least comprise a sensor, an optics component, and a coder, and the fifth determination sub-module includes a first determination unit, a second determination unit, and a third determination unit.

The first determination unit is configured to determine a simulation function set for simulating functions of the sensor, the optics component, and the coder of the calibrated camera respectively.

The second determination unit is configured to determine differentiability of each of simulation functions in the simulation function set.

The third determination unit is configured to, for each of the simulation functions, in response to that the differentiability of the simulation function does not meet a differential condition, determine a differentiable function that matches the simulation function, to obtain the differentiable function set.

In some embodiments, the neural network at least includes a coding module, an optics module, and a sensor module.

The coding module is determined based on a differentiable function of the coder.

The optics module is determined based on a differentiable function of the optics component, an output of the coding module is an input of the optics module.

The sensor module is determined based on a differentiable function of the sensor, an output of the optics module is an input of the sensor module.

In some embodiments, the first estimation sub-module includes a fourth determination unit, a fifth determination unit, a first adjustment unit, and a first estimation unit.

The fourth determination unit is configured to determine optimized differentiable functions in the trained neural network.

The fifth determination unit is configured to determine a functional component to be optimized from functional components simulated by the optimized differentiable functions.

The first adjustment unit is configured to adjust one or more parameters of the functional component to be optimized based on the optimized differentiable function corresponding to the functional component to be optimized, to obtain an optimized functional component.

The first estimation unit is configured to perform depth estimation on the scene to be estimated by using the camera with the optimized functional component, to obtain the scene depth.

In some embodiments, the optimized functional component includes at least one of a coder, an optics component, or a sensor.

It should be noted that the description of the above apparatus embodiment is similar to the description of the above method embodiment, and has similar beneficial effects as the method embodiment. For technical details not disclosed in the device embodiments of the disclosure, the description of the method embodiments of the disclosure may be referred to.

It should be noted that, in the embodiments of the disclosure, if the above method for depth estimation is implemented in a form of software function modules and sold or used as an independent product, it may be stored in a computer readable storage medium. Based on this understanding, the technical solutions of the embodiments of the disclosure that contributes to the prior art can be embodied in the form of a software product. The computer software product is stored in a storage medium and includes several instructions for a device for depth estimation (which may be a terminal, a server, etc.) to execute all or part of the method described in each embodiment of the disclosure. The aforementioned storage media include: U disk, mobile hard disk, read only memory (Read Only Memory, ROM), magnetic disk or optical disk and other media that can store program codes. The embodiments of the disclosure are not limited to any specific combination of hardware and software.

Correspondingly, an embodiment of the disclosure further provides a computer program product. The computer program product includes computer-executable instructions. The computer-executable instructions, when executed, can implement steps in the method for camera calibration provided in the embodiments of the disclosure.

Correspondingly, an embodiment of the disclosure further provides a computer storage medium with computer executable instructions stored in the computer storage medium, and the computer executable instructions, when executed by a processor, can implement steps in the method for camera calibration provided in the above embodiment.

Correspondingly, an embodiment of the disclosure provides a device for depth estimation. FIG. 9 is a block diagram of another device for depth estimation according to some embodiments of the disclosure. As shown in FIG. 9, the device 900 includes: a processor 901, at least one communication bus, a communication interface 902, at least one external communication interface, and a memory 903. The communication interface 902 is configured to perform connection and communication between these components. The communication interface 902 may include a display screen, and the external communication interface may include a standard wired interface and a wireless interface. The processor 901 is configured to execute an image processing program in the memory to implement the steps of the method for depth estimation provided in the foregoing embodiment.

The above description of embodiments of the apparatus for depth estimation, the device for depth estimation and storage medium is similar to the description of the above method embodiments, and has similar technical description and beneficial effects as the corresponding method embodiments, which will not be repeated here for the sake of simplicity. For technical details not disclosed in the embodiments of the apparatus for depth estimation, device for depth estimation, and storage medium of the disclosure, the description of the method embodiments of the disclosure may be referred to.

It should be understood that “one embodiment” or “an embodiment” mentioned throughout the specification means that a specific feature, structure, or characteristic related to the embodiment is included in at least one embodiment of the disclosure. Therefore, the appearance of “in one embodiment” or “in an embodiment” in various places throughout the specification does not necessarily refer to the same embodiment. In addition, these specific features, structures, or characteristics can be combined in one or more embodiments in any suitable manner. It should be understood that, in the various embodiments of the disclosure, the sequence number of the above-mentioned processes does not mean the execution order, and the execution order of each process should be determined by its function and internal logic, rather than limiting the implementation process of the embodiments of the disclosure. The sequence numbers of the foregoing embodiments of the disclosure are only for description, and do not represent the advantages and disadvantages of the embodiments.

It should be noted that in this article, the terms “include”, “include” or any other variants thereof are intended to cover non-exclusive inclusion, so that a process, method, article or device including a series of elements not only includes the elements, but also includes other elements not explicitly listed, or elements inherent to the process, method, article, or device. If there are no more restrictions, the element defined by the sentence “including a . . . ” does not exclude the existence of other identical elements in the process, method, article or device that includes the element.

It should be understood that, in the several embodiments of the disclosure, the disclosed device and method may be implemented in other ways. The device embodiments described above are merely illustrative. For example, the division of the units is only a logical function division, and there may be other divisions in actual implementation, for example, multiple units or components may be combined, or may be integrated into another system, or some features can be ignored or not implemented. In addition, the coupling, or direct coupling, or communication connection between the components shown or discussed may be indirect coupling or communication connection through some interfaces, devices or units, and may be electrical, mechanical or of other form.

The units described above as separate components may or may not be physically separate. The components displayed as units may or may not be physical units. The units may be located in one place or distributed on multiple network units. Some or all of the units may be selected as desired to achieve the purpose of the solution of the embodiments.

In addition, the functional units in the embodiments of the disclosure may be integrated into one processing unit, or each unit may be individually used as a unit, or two or more units may be integrated into one unit. The integrated unit may be implemented in a form of hardware, or in a form of hardware plus software function units. Those of ordinary skill in the art can understand that all or part of the steps in the above method embodiments can be implemented by a program instructing relevant hardware. The foregoing program can be stored in a computer readable storage medium. The program, when executed, executes the steps included the foregoing method embodiment; and the foregoing storage medium may include various media that can store program codes, such as a removable storage device, a read only memory (Read Only Memory, ROM), a magnetic disk, or an optical disk.

Alternatively, if the above-mentioned integrated units of the disclosure are implemented in a form of software function modules and sold or used as an independent product, it can also be stored in a computer readable storage medium. Based on this understanding, the technical solutions of the embodiments of the disclosure contributes to the prior art can be embodied in the form of a software product. The computer software product is stored in a storage medium and includes several instructions for a device for depth estimation (which may be a personal computer, a server, or a network device, etc.) executes all or part of the method described in each embodiment of the disclosure. The aforementioned storage media include: removable storage devices, ROMs, magnetic disks or optical disks and other media that can store program codes. The above are only specific implementations of the disclosure, but the protection scope of the disclosure is not limited thereto. Any person skilled in the art can easily think of changes or substitutions within the technical scope disclosed in the disclosure, which should be within the scope of the disclosure. Therefore, the scope of the disclosure should be subject to the scope of the claims.

1. A method for camera calibration, comprising:
determining a camera to be calibrated for performing depth estimation on a scene;
determining a first correlation function for characterizing a correlation between a sensor modulation signal of the camera to be calibrated and a first modulated light emission signal;
determining a second correlation function for characterizing an actual correlation function produced by the camera to be calibrated;
determining a calibrated impulse response based on the first correlation function and the second correlation function; and
calibrating the camera to be calibrated based on the calibrated impulse response, to obtain the calibrated camera.

2. The method of claim 1, wherein after calibrating the camera to be calibrated based on the calibrated impulse response, the method further comprises:
performing depth estimation on the scene based on the calibrated impulse response by using the calibrated camera, to obtain a scene depth.

3. The method of claim 1, wherein determining the first correlation function for characterizing the correlation between the sensor modulation signal of the camera to be calibrated and the first modulated light emission signal comprises:
determining a position relation between a sensor in the camera to be calibrated and an object to be detected;
in response to the position relation meeting a preset condition, determining the first modulated light emission signal that is emitted by an optics component of the camera to be calibrated, and a reflective signal of the first modulated light emission signal, which is reflected by the object to be detected;
modulating the reflective signal by using the sensor, to obtain the sensor modulation signal; and
taking a correlation function of the first modulated light emission signal and the sensor modulation signal to be the first correlation function.

4. The method of claim 1, wherein determining the calibrated impulse response based on the first correlation function and the second correlation function comprises:
deconvolving the first correlation function and the second correlation function to obtain a deconvolution result; and
determining the deconvolution result as the calibrated impulse response.

5. The method of claim 1, wherein after determining the calibrated impulse response based on the first correlation function and the second correlation function, the method further comprises:
changing a current frequency of the first modulated light emission signal to obtain a second modulated light emission signal;
determining a third correlation function for characterizing a correlation between the sensor modulation signal of the camera to be calibrated and the second modulated light emission signal;
determining a fourth correlation function for characterizing an actual correlation function produced by the camera to be calibrated with the second modulated light emission signal;
determining another calibrated impulse response based on the third correlation function and the fourth correlation function; and
updating the calibrated impulse response based on the another calibrated impulse response.

6. The method of claim 2, wherein performing depth estimation on the scene based on the calibrated impulse response by using the calibrated camera, to obtain the scene depth comprises:
determining a differentiable function set for simulating functional components of the calibrated camera;
creating a neural network for depth estimation based on the differentiable function set;
processing acquired sample scenes and the calibrated impulse response by using the neural network, to obtain a predicted depth for each of the sample scenes;
training the neural network based on a true depth and the predicted depth of each of the sample scenes, such that a depth error output by the trained neural network meets a convergence condition; and
performing depth estimation on the scene based on the trained neural network, to obtain the scene depth.

7. The method of claim 6, wherein the functional components of the calibrated camera at least comprise a sensor, an optics component, and a coder, and
wherein determining the differentiable function set for simulating the functional components of the calibrated camera comprises:
determining a simulation function set for simulating functions of the sensor, the optics component, and the coder of the calibrated camera;
determining differentiability of each of simulation functions in the simulation function set; and
for each of the simulation functions, in response to that the differentiability of the simulation function does not meet a differential condition, determining a differentiable function that matches the simulation function, to obtain the differentiable function set.

8. The method of claim 7, wherein the neural network at least comprises a coding module, an optics module, and a sensor module, wherein:
the coding module is determined based on a differentiable function of the coder;
the optics module is determined based on a differentiable function of the optics component, wherein an output of the coding module is an input of the optics module; and
the sensor module is determined based on a differentiable function of the sensor, wherein an output of the optics module is an input of the sensor module.

9. The method of claim 8, wherein performing depth estimation on the scene based on the trained neural network, to obtain the scene depth comprises:
determining optimized differentiable functions in the trained neural network;
determining a functional component to be optimized from functional components simulated by the optimized differentiable functions;
adjusting one or more parameters of the functional component to be optimized based on the optimized differentiable function corresponding to the functional component to be optimized, to obtain an optimized functional component; and
performing depth estimation on the scene to be estimated by using the camera with the optimized functional component, to obtain the scene depth.

10. The method of claim 9, wherein the optimized functional component comprises at least one of a coder, an optics component, or a sensor.

11. A device for camera calibration, comprising: a memory and a processor, wherein the memory stores computer executable instructions, and the processor, when running the computer executable instructions stored in the memory, is configured to:
determine a camera to be calibrated for performing depth estimation on a scene;
determine a first correlation function for characterizing a correlation between a sensor modulation signal of the camera to be calibrated and a first modulated light emission signal;
determine a second correlation function for characterizing an actual correlation function produced by the camera to be calibrated;
determine a calibrated impulse response based on the first correlation function and the second correlation function; and
calibrate the camera to be calibrated based on the calibrated impulse response, to obtain the calibrated camera.

12. The device of claim 11, wherein after calibrating the camera to be calibrated based on the calibrated impulse response, the processor is further configured to:
perform depth estimation on the scene based on the calibrated impulse response by using the calibrated camera, to obtain a scene depth.

13. The device of claim 11, wherein in determining the first correlation function for characterizing the correlation between the sensor modulation signal of the camera to be calibrated and the first modulated light emission signal, the processor is configured to:
determine a position relation between a sensor in the camera to be calibrated and an object to be detected;
in response to the position relation meeting a preset condition, determine the first modulated light emission signal that is emitted by an optics component of the camera to be calibrated, and a reflective signal of the first modulated light emission signal, which is reflected by the object to be detected;
modulate the reflective signal by using the sensor, to obtain the sensor modulation signal; and
take a correlation function of the first modulated light emission signal and the sensor modulation signal to be the first correlation function.

14. The device of claim 11, wherein in determining the calibrated impulse response based on the first correlation function and the second correlation function, the processor is configured to:
deconvolve the first correlation function and the second correlation function to obtain a deconvolution result; and
determine the deconvolution result as the calibrated impulse response.

15. The device of claim 11, wherein after determining the calibrated impulse response based on the first correlation function and the second correlation function, the processor is further configured to:
change a current frequency of the first modulated light emission signal to obtain a second modulated light emission signal;
determine a third correlation function for characterizing a correlation between the sensor modulation signal of the camera to be calibrated and the second modulated light emission signal;
determine a fourth correlation function for characterizing an actual correlation function produced by the camera to be calibrated with the second modulated light emission signal;
determine another calibrated impulse response based on the third correlation function and the fourth correlation function; and
update the calibrated impulse response based on the another calibrated impulse response.

16. The device of claim 12, wherein in performing depth estimation on the scene based on the calibrated impulse response by using the calibrated camera, to obtain the scene depth, the processor is configured to:
determine a differentiable function set for simulating functional components of the calibrated camera;
create a neural network for depth estimation based on the differentiable function set;
process acquired sample scenes and the calibrated impulse response by using the neural network, to obtain a predicted depth for each of the sample scenes;
train the neural network based on a true depth and the predicted depth of each of the sample scenes, such that a depth error output by the trained neural network meets a convergence condition; and
perform depth estimation on the scene based on the trained neural network, to obtain the scene depth.

17. The device of claim 16, wherein the functional components of the calibrated camera at least comprise a sensor, an optics component, and a coder, and
wherein in determining the differentiable function set for simulating the functional components of the calibrated camera, the processor is configured to:
determine a simulation function set for simulating functions of the sensor, the optics component, and the coder of the calibrated camera;
determine differentiability of each of simulation functions in the simulation function set; and
for each of the simulation functions, in response to that the differentiability of the simulation function does not meet a differential condition, determine a differentiable function that matches the simulation function, to obtain the differentiable function set.

18. The device of claim 17, wherein the neural network at least comprises a coding module, an optics module, and a sensor module, wherein:
the coding module is determined based on a differentiable function of the coder;
the optics module is determined based on a differentiable function of the optics component, wherein an output of the coding module is an input of the optics module; and
the sensor module is determined based on a differentiable function of the sensor, wherein an output of the optics module is an input of the sensor module.

19. The device of claim 18, wherein in performing depth estimation on the scene based on the trained neural network, to obtain the scene depth, the processor is configured to:
determine optimized differentiable functions in the trained neural network;
determine a functional component to be optimized from functional components simulated by the optimized differentiable functions;
adjust one or more parameters of the functional component to be optimized based on the optimized differentiable function corresponding to the functional component to be optimized, to obtain an optimized functional component; and
perform depth estimation on the scene to be estimated by using the camera with the optimized functional component, to obtain the scene depth.

20. A non-transitory computer readable storage medium, having computer executable instructions stored thereon, and the computer executable instructions, when executed, implement a method for camera calibration, comprising:
determining a camera to be calibrated for performing depth estimation on a scene;
determining a first correlation function for characterizing a correlation between a sensor modulation signal of the camera to be calibrated and a first modulated light emission signal;
determining a second correlation function for characterizing an actual correlation function produced by the camera to be calibrated;
determining a calibrated impulse response based on the first correlation function and the second correlation function; and
calibrating the camera to be calibrated based on the calibrated impulse response, to obtain the calibrated camera.
